(19) United States
(12) Patent Application Publication
(10) Pub. No.: US 2016/0321932 A1
(43) Pub. Date: Nov. 3, 2016

(54) Systems and methods to achieve group exercise outcomes

(71) Applicants: Ying Chieh Mitchell, Palo Alto, CA (US); Justin Hanyan Wong, Atherton, CA (US)

(72) Inventors: Ying Chieh Mitchell, Palo Alto, CA (US); Justin Hanyan Wong, Atherton, CA (US)

(21) Appl. No.: 14/545,390

(22) Filed: Apr. 29, 2015

(51) Int. Cl. G09B 5/02; G09B 19/00

(52) U.S. Cl. CPC G09B 5/02; G09B 19/003

(57) ABSTRACT

A system and method for allowing a person to remotely participate in a group exercise program and receive feedback without being physically present at a health fitness studio with a live instructor. A computer system is used to record the movements of group exercise instructors in the form of an instructor file and subsequently show the instructor in the form of a video or an avatar or other animated representation on a display at the remote participant's location. The movements of remote participants are captured by networked computers or integrated game consoles equipped with motion capturing cameras operating in conjunction with 3D full body capture software. The movement data captured by the camera system is transmitted to a remote server. The server can place a representation of participants in a participant-selectable virtual scene such as a fitness studio or outdoor location. The virtual scene and animated representations of multiple participants may be displayed to each participant with the instructor representation and each participant's avatar enlarged on their own monitor. A pre-recorded virtual instructor or live instructor is presented in the studio to lead the group in a sequence of pre-recorded or live exercise routines. Exercise outcome and improvement suggestions based on biomechanics analysis determined by an instructor or software application are communicated to each individual participant. Individual recommendations for follow-on exercise programs or products such as exercise equipment may also be supplied to participants to improve outcomes or accelerate the attainment of desired goals.

This application relates generally to networked interactive systems and more particularly to systems for promoting group exercise and measuring biomechanical outcome with one or more participants who are remote from a group exercise instructor and each other.

### BACKGROUND

Group exercise promotes social interaction and delivers better outcomes for many participants than is achieved with individual exercise. These outcomes pertain to the different dimensions of wellness that include physical, emotional, social, intellectual, spiritual, and environmental; all of which are interrelated and influence each other in a dynamic process of growth and change. As such, there are an increasing number of choices of group exercise programs as the health and fitness industry strives to keep everyone active and healthy. Though individuals will find a particular group exercise class(es) that they enjoy most i.e. instructor, class style and the other participants, it is not always feasible to attend that particular class. Therefore, an optimal solution is to provide a means where individuals in remote locations can either work out with the instructor only or with other participants during a pre-designated class time or schedule a class with a specific instructor and participants. This option may also be extended to a single player mode and/or pre-recorded sessions.

U.S. Pat. No. 8,376,910 to Cheung et al. describes a computer-based network for providing remote participation in a group exercise setting. More particularly a system is described which allows competition between various participants by monitoring the effort or work output of each participant and displaying icons on a video display of the relative position of each participant in a virtual race.

It is also known to use avatars or other representations to depict individual participants in multi-player video games and in on-line competitive gaming contests. This is also seen with (1) personal computer systems running on various operating systems including, but not limited to, Windows, Mac OS or Linux families of operating systems, or (ii) commonly available integrated video game consoles including, but not limited to, the Wii, Xbox, and Playstation platforms. In addition, these systems may provide participants video motion tracking to assist in presenting the movements of participants through an avatar on the display screen. Consumer-oriented “wearable” monitoring devices linked to mobile devices including, but not limited to, cell phones, tablet computers or data aggregators might also be deployed to monitor the physical vital statistics of the participants.

What none of these systems provide is the coaching benefit of having a group exercise instructor provide remote feedback including but not limited to verbal and visual instructions, motivational encouragement, and exercise outcome parameters. These parameters include but not limited to calories burned, and corrections to body mechanics and body alignment based on factors such as the live or recorded movements of the participants, biomechanical principles, and measured physical vital statistics.

### BRIEF SUMMARY

The present application discloses a novel system in which a person can participate in a group exercise program and receive feedback without being physically present at a health fitness studio with a live instructor. The system of the present application may be used to project the reach of group exercise instructors and increase accessibility for exercise participants to join group exercise classes at their convenience or in the privacy of their home. In a preferred embodiment, a computer system is used to record the movements of group exercise instructors which are subsequently displayed in the form of recorded images, an avatar or other animated representation on a display such as a television or computer monitor. Said computer system can also be deployed to transmit the movements of group exercise instructors as life images, an avatar or other animated representation in case of classes conducted in real time. The movements of the remote participants within the group settings are captured by the networked computers or integrated game consoles equipped with motion capturing cameras operating in conjunction with motion sensing and capture software including, but is not limited to, the Xbox Kinect and the Playstation Camera. The movement data captured by the camera system are transmitted to a server via a communications network. The server will place the participants in a participant-selectable virtual scene that might include, but is not limited to, a fitness studio, an outdoor location (e.g., a beach or historical site like the Taj Mahal or on top of the Great Wall), and/or an indoor location (e.g., Grand Central Station or on a Broadway stage). The virtual scene and animated representation of all the participants are displayed on each participant's computer monitor or television, with the participant's avatar enlarged on their monitor. A pre-recorded virtual instructor, or live instructors in front of a motion tracking computer and camera system, is placed in the studio to lead the group in a sequence of pre-recorded or live exercise routines. Music and other sound effect could also be transmitted to enliven the exercise routine. Exercise outcome and improvement suggestions based on biomechanical principles and measured physical vital statistics (if available or appropriate) are algorithmically determined by a software application that resides on the server and/or computer located at the remote location. The outcomes and suggestions may be communicated in real-time or after the session via the computer program, email, web portal, mobile app, other communication means or other combination thereof to each individual participant and the group collectively. Individual recommendations for follow-on exercise programs (e.g. yoga for flexibility, or tai chi for breathing) or products (e.g., health supplements or exercise equipment) may also be made to participants to improve outcomes or accelerate the attainment of desired goals. Participants may interact with each other through motion or voice to promote positive group reinforcement, motivation, and camaraderie. Participants may also share a recording of their session privately with friends on social media, or publicly on web sites of video distribution outlets.

Though group exercise classes taught in fitness facilities by a live instructor are the most effective, it might not fit the participant's needs for reasons such as cost, scheduling, and time. Therefore, another embodiment of this invention is to have a live instructor in front of a tracking computer and camera system while teaching in the fitness facility with live participants and remote participants. Furthermore, instructors for special exercise programs might not be available in the local area of the interested participants, or not enough participants are available in a local area to warrant a live session by the instructor. These sessions may be archived and saved for future use to allow participants to access the sessions at their convenience.

Group exercise programs that may be delivered using this invention include, but are not limited to, aerobic dance, folk dance, classical dance, modern dance, yoga, martial arts including tai chi, yoga, stretching, special weight training program, etc.

### BRIEF DESCRIPTION OF THE DRAWINGS

Referring now to the drawings wherein like elements are numbered alike in several FIGURES:

FIG. 1 is a block diagram of a system upon which remote participation within group exercise events may be implemented in a preferred embodiment;

FIG. 2 is a block diagram of a system upon which remote participation within group exercise events may be implemented in an alternative embodiment;

FIG. 3 is a flow diagram illustrating the process for implementing remote participation within group exercise events in a preferred embodiment;

FIGS. 4A-4C illustrate sample monitor screen windows for initiating remote participation in group exercise events;

FIG. 5 shows a user interface screen illustrating a sample group exercise event as displayed on the remote participant system.

### DETAILED DESCRIPTION

In accordance with the embodiments shown in the drawings, remote participation within group exercise events is provided with real-time and/or live feedback to participants based on performance data. The group exercise events offer participants a variety of physical activity programs that can be remotely accessed from within the comfort and privacy of their home and the opportunity to engage in social interaction within a virtual setting.

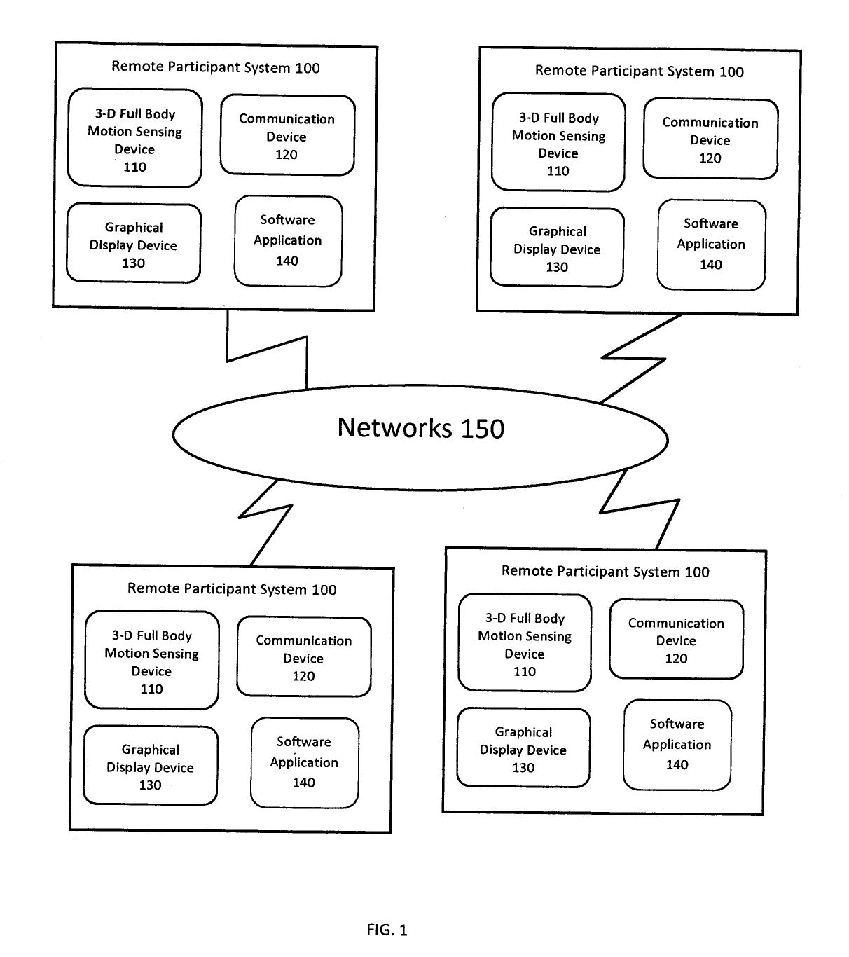

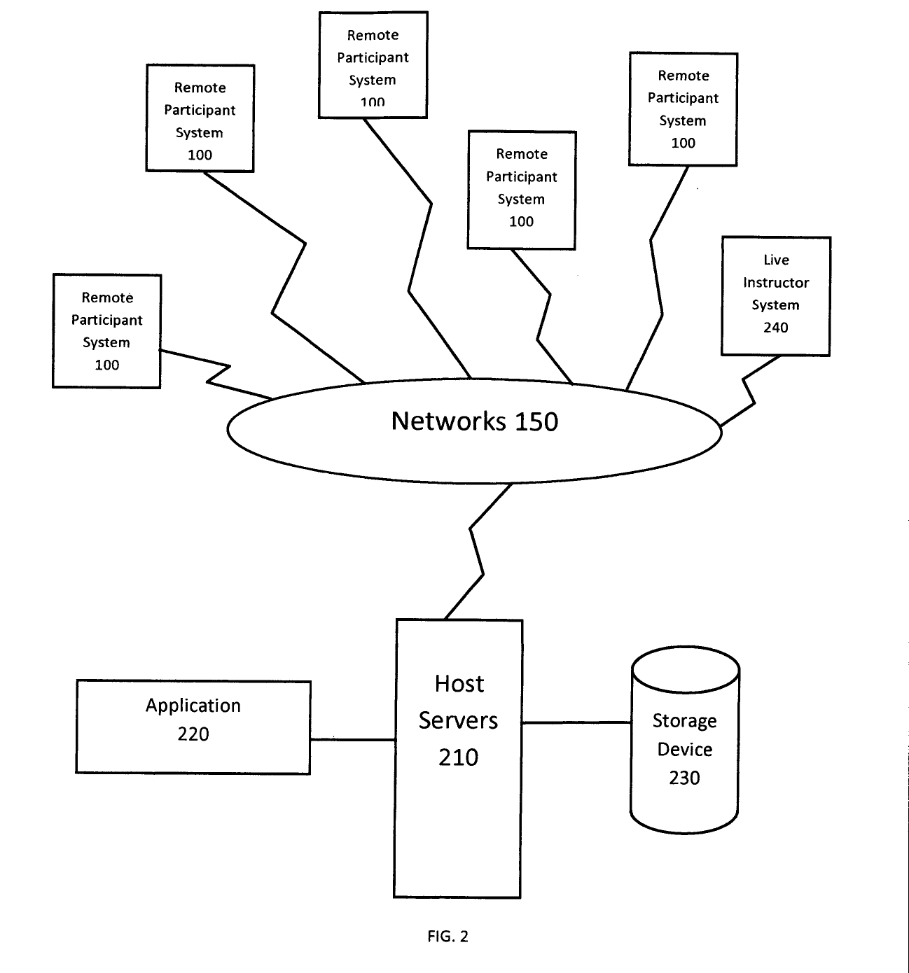

Referring to FIG. 1, remote participant systems 100 provide the user interface and include game console(s) equipped with motion capturing cameras and/or full body motion sensing devices 110, communication devices 120 such as the microphones commonly found packaged with the game consoles, and software applications 140. A television or computer monitor may provide the graphical display 130 that shows the instructors and participants within the virtual scene and is used to provide feedback. Alternatively, a personal computer equipped with a camera having motion detection and capturing software 110, communication device 120 either the microphone built into the computer or other commercially available microphones, and software application 140 may be integrated as part of the user interface. Mobile devices such as mobile phones or tablets may be used to extend the reach of the group exercise event. In an alternate embodiment shown in FIG. 2, a live instructor system 240 may be included within group exercise events. The user interface may be similar to that of the remote participant system 100. This embodiment may also include host servers 210 with application 220 and storage device 230 to process different embodiments (not shown).

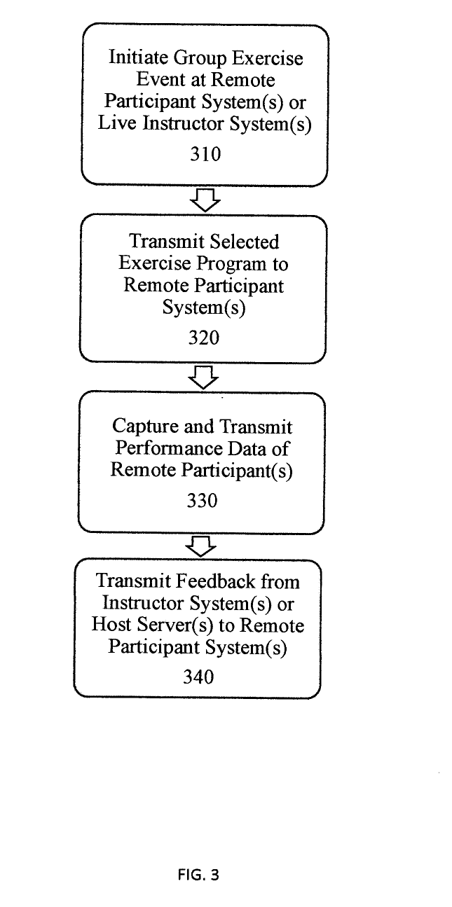

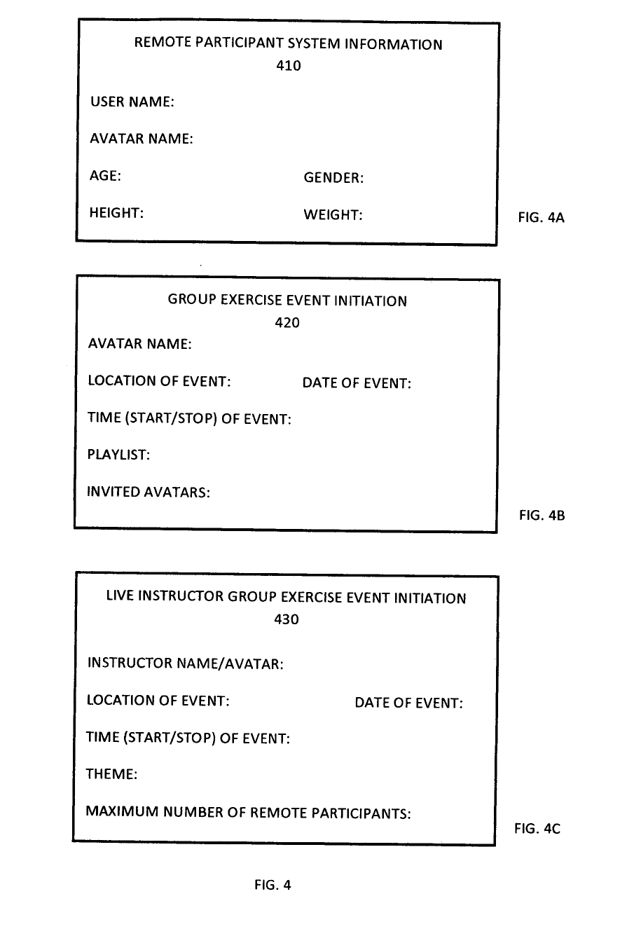

The remote participant system 100 and/or the live instructor system 240 may initiate the group exercise event by launching the appropriate software application as shown in box 310 of FIG. 3. The remote participant(s) and/or live instructor(s) enter the appropriate data as guided by the program, shown in monitor screen windows 410, 420, and 430 of FIGS. 4A-4C. A group exercise event(s) lead by live instructor(s) may transmit the live instruction file from the live instructor system 240 to the remote participant system 100 via the networks 150. In FIG. 3, box 320 shows that the selected instruction file, initiated by a remote participant, may be transmitted to the remote participant system 100 either by the application 220 that resides on the host server 210 via networks 150 and/or from the software application 140 residing on the remote participant system 100. Body movements of the user may be captured by motion capturing cameras and/or the full body motion sensing device 110 and transmitted as a participant file to the software application 140 on the remote participant system 100 and/or via the networks 150 to another remote participant system 100 or host server 210 and host application 220 for analysis and interpretation of biomechanics.

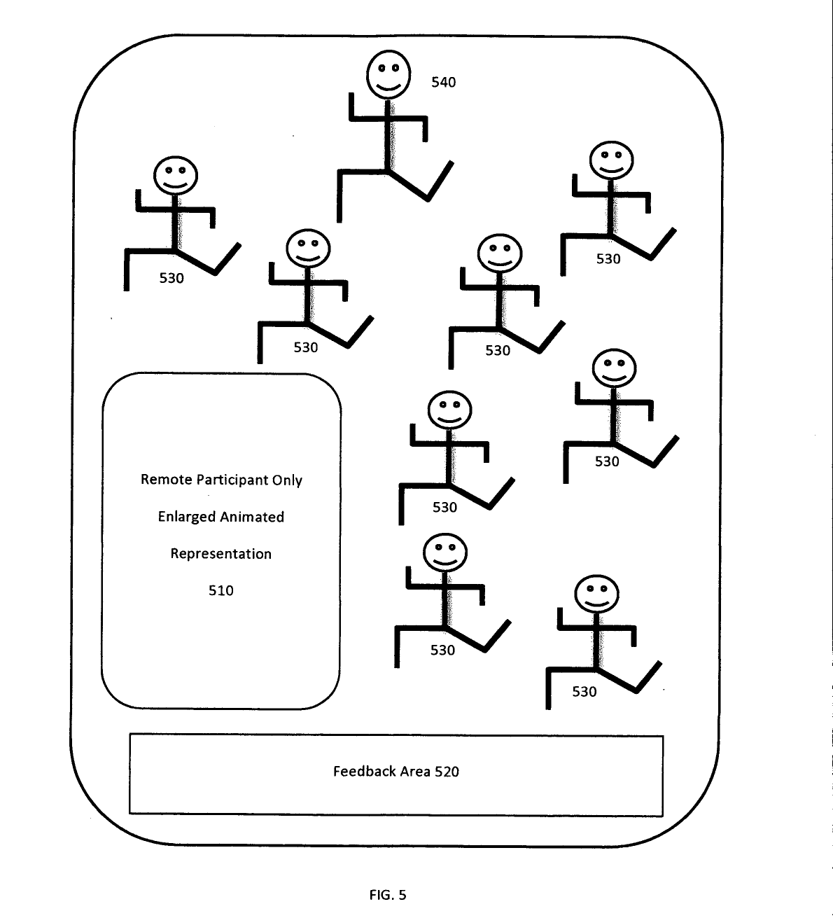

An embodiment of the software application 140 and 220 is based on the Kinesiologic Model (Diagnosis and Treatment of Movement Impairment Syndromes, Sahrmann, 2002, pp 9-10). It describes movement as a system made up of several elements, specifically (1) base, (2) modulator, (3) biomechanical, and (4) support. The components within each element are:
(1) Base: muscular and skeletal system
(2) Modulator: nervous system
(3) Biomechanical: static and dynamics
(4) Support: cardiac, pulmonary, and metabolic systems
   Every component as well as the interaction among the components is essential to movement. Optimal function of the movement system is maintained when there is periodic movement and variety in the direction of the movement of specific joints. The performance data, captured by the motion-capturing device 110 and/or other wearable devices, such as joint position and heart rate is analyzed for biomechanics with algorithms based on normal and ideal movement of joints. For example, the motions and the normal range of motion (in degrees) for the shoulder girdle include flexion to 180°, extension to 45°-65°, abduction to 180°, adduction to 0°, external rotation to 90°, and internal rotation to 70°. The software application 140 and 220 evaluates the movement, real-time, with a rubric that includes but is not limited to joint positioning with respect to other joints during a movement, path of instantaneous center of rotation, abnormal movement, and user-provided health history. Appropriate feedback including but not limited to corrections and adjustments to joint alignment, body posture, body mechanics, and techniques are provided. For example, a common error during execution of a split squat jump is that the shoulders do not remain back and in line with the hips that leads to decreased stability (NCSA's Essentials of Personal Training, 2^{nd} edition, p. 443). Upon analysis of a participant's file indicating that the participant is performing this movement with improper joint alignment, the software application 140 and 220 will transmit feedback to the participant in the feedback area 520 and/or verbally as shown in FIG. 5. The message, written or verbal, would be similar to “Please keep your shoulders over your hips before you jump up and as you land. This will help you with stability”. Additionally, areas of improvement, and recommendation for other programs and products beneficial to the participant can be provided in real-time and in some instances, live, by the instructor. Individual and group feedback or coaching may be provided to participants on the remote participant system 100 verbally and/or visually. Area 520 represents an option for visual feedback given to a participant on the remote participant system 100. Alternatively, feedback may be given verbally via the communication device 120.

In addition, motivational encouragement, verbal and non-verbal instructional cueing, verbal and non-verbal transitional cueing, and exercise outcome data may be provided on a real-time basis. Participants may also capture and store their live images on the remote participant system 100, to be distributed via social media channels such as Facebook, Youtube, and Twitter.

The live instructor(s) can be located remotely and/or in a fitness facility with other live participants. In both scenarios, an animated instruction file such as avatars of the remote participant system(s) 100 may be projected onto a display screen. The captured participants' files from multiple remote participant systems 100 may be transmitted to host server 210 via the networks 150. The application 220 on the host server 210 may analyze the participant's file of each remote participant system 100 as well as collectively. The files and information may be stored in the storage device 230 residing with the host server 210. Appropriate feedback including but not limited to that described above is given. In addition, the live instructor system(s) 240 may provide live real-time feedback during the group exercise event to one or all of the remote participant systems 100 via a communication device similar to that of communication device 120. Remote participant system(s) 100 may also use the communication device 120 to provide feedback and support to each other, such as words of encouragement, cheering and challenging each other, and sharing experiences or other health information.

FIGS. 4A-4C show sample user interfaces for initiating a group exercise event. Fields include but are not limited to selection of an avatar, setting individual and group goals, organizing groups or communities of remote participants, communicating within the group, recruiting new participants via social networks, designating date and time of event, and selection of event theme and playlist. The instruction file, consisting of a sequence of music and/or instructions only, and instructor movement and voice command, may be pre-recorded or delivered in real time by a live instructor. Instructors may pre-record instruction files using a range of computer recording systems including, but not limited to, movement sensing device-equipped computer game consoles. The sequence of music (or instruction only) and instructor movement of any “live” session delivered by an instructor may be recorded and stored as a pre-recorded instruction file. A library of pre-recorded instruction file may be categorized and stored in a library (the “Codex”). Instruction files may be selected from a library categorized by interest, type of exercise, duration, level of difficulty, or other selection criteria.

Another user interface (not shown) may allow users to select the option of using different modes such as “Training” mode (offline mode where captured data is not transmitted through networks 150) or the “Group” Mode (online mode where captured data is transmitted as a participant file through networks 150). In the “Training” mode, the users may either participate in instruction files downloaded from the Codex in the “Group” (online) mode, or review previous sessions and compare progression and improvements over time. In the “Group” mode, the users may participate in “Live Training” which shows instructions files that are currently running, how much time left in that session, and gives the participant the option to join. Once the “Live Training” is over, it may be archived and put into the Codex. This allows the users to view archived (past) instruction files and participate in them by themselves or with friends at their convenience. Another option for the participants is to create a session. As shown in FIG. 4B, this option may give the participants the power (i) to set when the session will start and end, (ii) who the instructor will be, (iii) what the instruction file will be, and (iv) whether to make the session private or public. A private session is accessible only by those who have been invited, while a public program is accessible to the general population. A further option is to review previous sessions and compare how they have improved or not over time. Unlike the review function in “Training” mode, the review function in “Group” mode may also benchmark the user's results against a population of participants who have taken that same program.

When users select an instruction file from the Codex, they may be given options such as: (i) start the instruction file right away, (ii) enter the tutorial mode where the instructor may show the movements step by step (as a point of illustration: in yoga, the tutorial mode may show the optimal pose and the user may imitate or repeatedly practice the pose), or (iii) download the instruction file into the memory of remote participant system 100 so that users may use it in Training mode.

The data processing at the host server(s) 210 and/or remote participant system(s) 100 may create the virtual scene of the group exercise events, place the live and/or animated participant file 530, such as avatars, and instructors 540 in such a scene, and deliver the instruction file(s) to remote participant system 100 via the networks 150. Upon receiving animated participant file(s) from the remote participant system(s) 100, the host server(s) 210 and/or remote participant system 100 may display the animated representation of the movement of the participants based on the captured movement data from the full body motion sensing device 110 in the virtual studio scene in relation to other participants and/or the instructor(s). FIG. 5 illustrates a sample virtual studio scene that may be displayed on the remote participant system 100. The participant file may be stored on the storage device 230 and/or remote participant system 100 for future analysis and coaching. As mentioned above, the instructor feedback and coaching is real-time and in some instances, live. It includes but is not limited to performance outcome metrics, adjustments to movements based on principles of biomechanics, areas of improvement, and recommendation for other programs and products beneficial to the participant.

In addition to an animated representation of the participant within the virtual studio scene, the option to enlarge the animated representation 510 of the participant and/or instructor may be available. This area on the monitor display of the remote participant system 100 may allow the participant to monitor and track their movements along with the instructor(s)' movements. Feedback area 520 in FIG. 5 shows an area on the monitor display for visual feedback from the instructor and/or other participants in the virtual studio scene.

Techniques used in the video gaming industry, including but not limited to, competition, earning points, and speed may be implemented to motivate the participants. The competitive aspect of this invention may come from comparing the participant's score (how accurately one matched the moves, and ability to keep-up with a sequence of moves shown by the instructor), and physical parameters (weight, height, etc. from FIG. 4A) with previous data and other participants' data. Points may be earned based on these comparisons and other parameters, and redeemed for rewards such as props and apparel.

What is claimed is:

1. A method for providing distributed group exercise instruction, comprising:
capturing an image of an instructor leading a group exercise event using an instructor component having video capture and communication capability;
creating an instruction file from said captured image;
communicating said instruction file to at least one remote participant computer for display of said instruction file on a participant display;
receiving at an instructor server a participant file representing an image of said at least one participant captured from said participant's participation in said group exercise event;
analyzing biomechanics of participant form from said participant file; and
providing feedback to said participant regarding said analyzed biomechanics.

2. The method of claim 1 further including converting said captured image of said instructor leading a group exercise event into an animated instruction file.

3. The method of claim 1 further including converting said captured image of said participant into an animated participant file.

4. The method of claim 1 wherein said biomechanics analysis is performed by a computer.

5. The method of claim 4 and further including providing instructions to said participant regarding suggestions for adjusted performance based on said biomechanics analysis.

6. The method of claim 1 wherein said instructor component includes a server and an instructor computer connected to said server and wherein said analyzing biomechanics step is performed by software operating on said instructor computer.

7. The method of claim 1 wherein said step of biomechanics analysis is performed by an instructor.

8. The method of claim 1 further including the steps of displaying said instruction file at said at least one participant's location and displaying images of other participants in said group exercise event on a display at said at least one participant's location.

9. The method of claim 1 wherein said step of analyzing biomechanics includes analyzing the joint alignment of said participant during exercise execution.

10. The method of claim 8 wherein said step of displaying said instruction file on a display at said participant location further includes displaying an avatar of said participant performing exercise on said display.

11. The method of claim 10 further including displaying avatars of multiple participants on said display at said participant's location.

12. A system for providing distributed group exercise instruction, comprising:
an instructor component including a video capture mechanism for capturing an image of an instructor leading a group exercise event and creating an instruction file therefrom;
a communication component for communicating said instruction file to at least one remote participant computer for display of said instruction file on a participant display;
an instructor server for receiving a participant file representing an image of said at least one participant captured from said participant's participation in said group exercise event;
a software program operating on an instructor computer for analyzing biomechanics of participant form from said participant file; and
said communication component further including a capability for providing feedback to said participant regarding said analyzed biomechanics.

13. The system of claim 12 further including software for converting said captured image of said instructor leading a group exercise event into an animated instruction file.

14. The system of claim 12 further including software for converting said captured image of said participant into an animated participant file.

15. The system of claim 12 further including software operating on said instructor computer for biomechanics analysis of said participant file.

16. The system of claim 15 wherein said software further includes means for providing instructions to said participant regarding suggestions for adjusted performance based on said biomechanics analysis.

17. The system of claim 12 wherein said instructor component includes a server and an instructor computer connected to said server and wherein said analyzing biomechanics step is performed by software operating on said instructor computer.

18. The system of claim 12 wherein said software operating on said instructor computer includes code for analyzing biomechanics including analyzing the joint alignment of said participant during exercise execution.

19. The system of claim 14 wherein said animated participant file includes at least one participant selected avatar of said participant performing exercise on said display.

20. The method of claim 19 further including means for displaying avatars of multiple participants on said display at said participant's location.
